(19) United States
(12) Patent Application Publication
(10) Pub. No.: US 2013/0201065 A1
(43) Pub. Date: Aug. 8, 2013

(54) WIRELESS COMMUNICATIONS DEVICE HAVING LOOP ANTENNA WITH FOUR SPACED APART COUPLING POINTS AND ASSOCIATED METHODS

(71) Applicant: Francis Eugene Parsche, Palm Bay, FL (US)

(72) Inventor: Francis Eugene Parsche, Palm Bay, FL (US)

(73) Assignee: Harris Corporation, Melbourne, FL (US)

(21) Appl. No.: 13/364,929

(22) Filed: Feb. 2, 2012

(51) Int. Cl. H01Q 11/12; H01P 11/00

(52) U.S. Cl. 343/743; 29/600

(57) ABSTRACT

A wireless communications device includes wireless communications circuitry and an antenna coupled to the wireless communications circuitry. The antenna includes a loop electrical conductor having four spaced apart gaps therein defining four respective spaced apart coupling points, and a feed assembly. The feed assembly includes at least one antenna feed, and four signal feed lines, each signal feed line coupled between the at least one antenna feed and a respective one of the four coupling points. The antenna may provide linear polarization, circular polarization, and dual polarization.

### FIELD OF THE INVENTION

The present invention relates to the field of communications, and more particularly, to loop type antennas, circular polarization, dual polarization and related methods.

### BACKGROUND OF THE INVENTION

The use of satellite communications has increased the demand for circularly polarized antennas and for dual polarization antennas. For instance, many of the satellite transponders in use today carry two programs on the same frequency by using separate polarizations. Thus, single antenna structure may be called upon to simultaneously receive two polarizations, or perhaps to transmit in one polarization and receive in another. The single antenna structure should therefore separate the two polarization channels, to a high degree of isolation.

It is possible to have dual linear or dual circular polarization channel diversity. That is, a frequency may be reused if one channel is vertically polarized and the other horizontally polarized. Or, a frequency can also be reused if one channel uses right hand circular polarization (RHCP) and the other left hand circular polarization (LHCP). Polarization refers to the orientation of the E field in the radiated wave, and if the E field vector rotates in time, the wave is then said to be rotationally or circularly polarized.

An electromagnetic wave has an electric field that varies as a sine wave within a plane coincident with the line of propagation, and the same is true for the magnetic field. The electric and magnetic planes are perpendicular and their intersection is in the line of propagation of the wave. If the electric-field plane does not rotate (about the line of propagation) then the polarization is linear. If, as a function of time, the electric field plane (and therefore the magnetic field plane) rotates, then the polarization is rotational. Rotational polarization is in general elliptical, and if the rotation rate is constant at one complete cycle every wavelength, then the polarization is circular.

The polarization of a transmitted radio wave is determined in general by the antennas shape and the type of current flowing on that shape. In general, antenna types may be classified as to dipoles and loops, based on the divergence or curl of current. The canonical forms of the dipole and loop antennas are the line and circle. Of course there can be hybrid antennas that use both divergence and curl. Preferred antenna shapes are often Euclidian, being simple geometric shapes known for optimization through the ages.

For example, the monopole antenna and the dipole antenna are two common examples of divergence antennas with linear polarization. A helix antenna is a common example of a hybrid divergence and curl antenna with circular polarization. Another example of a circularly polarized antenna is a crossed array of dipoles fed in phase quadrature, e.g. the “Turnstile”. Linear polarization is usually further characterized as either Vertical or Horizontal. Circular Polarization is usually further classified as either Right Hand or Left Hand.

The dipole antenna has been perhaps the most widely used of all the antenna types. It is of course possible however to radiate from a conductor which is not constructed in a straight line. Approaches to circular polarization in loop antennas appear lesser known, or perhaps even unknown in the purest forms. In spite of the higher gain of the full wave loop vs. the half wave dipole (3.6 dBi vs. 2.1 dBi), dipoles are commonly used for circular polarization needs, as for instance in turnstile arrays. A circle antenna structure can be more suited for circular polarization than an X antenna. Both the dipole turnstile and a single loop antenna are planar, in that their thin structure lies nearly in a single plane.

Many structures are described as loop antennas, but the circle shape best provides the curling motion, and a circle advantageously provides the most area for the least circumference. The resonant loop is a full wave circumference circular conductor, often called a “full wave loop”. The typical prior art full wave loop is linearly polarized, having a radiation pattern that is a two petal rose, with two opposed lobes normal to the loop plane, and a gain of about 3.6 dBi. Reflectors are often used with the full wave loop antenna to obtain a unidirectional pattern.

Dual linear polarization (simultaneous vertical and horizontal polarization from the same antenna) has commonly been obtained from crossed dipole antennas. For instance, U.S. Pat. No. 1,892,221 to Runge, proposes a crossed dipole system. Polarization diversity was recited. The embodiment shown in FIG. 3 and described on page 2 lines 20-29 also provided circular polarized reception.

U.S. Pat. No. 5,977,921 to Niccolai et al. is directed to an antenna for transmitting and receiving circularly polarized electromagnetic radiation which is configurable to either right-hand or left-hand circular polarization. The antenna has a conductive ground plane and a circular closed conductive loop spaced from the plane, i.e., no discontinuities exist in the circular loop structure. A signal transmission line is electrically coupled to the loop at a first point and a probe is electrically coupled to the loop at a spaced-apart second point. This antenna requires a ground plane and includes a parallel feed structure, such that the RF potentials are applied between the loop and the ground plane. The “loop” and the ground plane are actually dipole half elements to each other, and the invention is related to microstrip antennas.

U.S. Pat. No. 5,838,283 to Nakano is directed to a loop antenna for a circularly polarized wave. Driving power fed may be conveyed to a feeding point via an internal coaxial line and a feeder conductor is transmitted through an I-shape conductor to a C-type loop element disposed in spaced facing relation to a ground plane. By the action of a cutoff part formed on the C-type loop element, the C-type loop element radiates a circularly polarized wave. Dual linear, or dual circular polarization are not however provided.

U.S. Pat. No. 6,522,302 to Iwasaki is directed to a circularly polarized antenna array rather than a single circularly polarized loop element. A circle is among the most elemental of antenna structures, and it is a fundamental single geometry capable of circular polarization.

U.S. Pat. Pub. No. 2008/0136720 to Parsche, the inventor of the present application, discloses a multiple polarization loop antenna which includes a circularly polarized loop antenna. The circularly polarized loop antenna utilizes a loop electrical conductor and two signal feedpoints along the loop electrical conductor separated by one quarter of the length of the loop circumference for a signal feedpoint phase angle input difference of 90 degrees. Each of the signal feedpoints includes a loop discontinuity, so that at least one signal source coupled thereto provides circular polarization from the loop electrical conductor. The circularly polarized loop antenna provides an increase in gain and decrease in size relative to the dipole turnstile. It can provide two orthogonal polarizations from two isolated ports, and the polarizations may be dual linear or dual circular.

While U.S. Pat. Pub. No. 2008/0136720 represents an exemplary advance in the field of circularly polarized loop antennas, further advances are still desirable. For example, improvement to the degree of circularity of the polarization can help improve antenna performance, and a single antenna structure capable of both circular and linear polarization would be useful in some applications.

### SUMMARY OF THE INVENTION

In view of the foregoing background, it is therefore an object of the present invention to provide a wireless device having an antenna that can be configured for different polarizations.

This and other objects, features, and advantages in accordance with the present invention are provided by a wireless communications device that includes wireless communications circuitry and an antenna coupled to the wireless communications circuitry. The antenna circuitry has a loop electrical conductor having four spaced apart gaps therein defining four respective spaced apart coupling points. The wireless communications device may also include a feed assembly comprising at least one antenna feed, and four signal feed lines, each signal feed line coupled between the at least one antenna feed and a respective one of the four coupling points.

As will be explained in detail below, this antenna allows the antenna to operate using both linear and circular polarization, for example, and provides robust performance. For example, the four signal feed lines may provide phase delays of 0°, 90°, 180°, and 270°, respectively, thereby configuring the wireless communications device for circular polarization. Alternatively, the four signal feed lines may provide phase delays of −180°, 0°, 0°, and 180°, respectively, thereby configuring the wireless communications device for linear polarization.

A method aspect is directed to a method of making an antenna to be used in a wireless communications device having wireless communications circuitry. The method comprises forming a loop electrical conductor having four spaced apart gaps therein defining four respective spaced apart coupling points. The method also includes forming a feed assembly by forming four signal feed lines and coupling each of the four signal feed lines between at least one antenna feed and a respective one of the four coupling points.

### BRIEF DESCRIPTION OF THE DRAWINGS

FIG. 1 is a schematic diagram of an embodiment of a wireless communications device in accordance with the present invention wherein the antenna is configured for circular polarization operation.

FIG. 2 is a schematic diagram of an embodiment of a wireless communications device in accordance with the present invention wherein the antenna is configured for simultaneous left hand and right hand circular polarization operation.

FIG. 3 is a schematic diagram of an embodiment of a wireless communications device in accordance with the present invention wherein the antenna is configured for linear polarization operation.

FIG. 4 is a schematic diagram of an embodiment of a wireless communications device in accordance with the present invention wherein the antenna is configured for both horizontal and vertical linear polarization operation.

FIG. 5A is a diagram depicting the antenna of FIG. 1 in a standard radiation pattern coordinate system.

FIGS. 5B-5D are graphs depicting the principal plane radiation pattern cuts of the antenna of FIG. 1 in free space.

FIG. 6 is a plot of the voltage standing wave ratio (VSWR) response at a loop port on the antenna of FIG. 1.

FIG. 7 is a plot of the impedance response at a loop port on the antenna of FIG. 1, in Smith Chart format.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

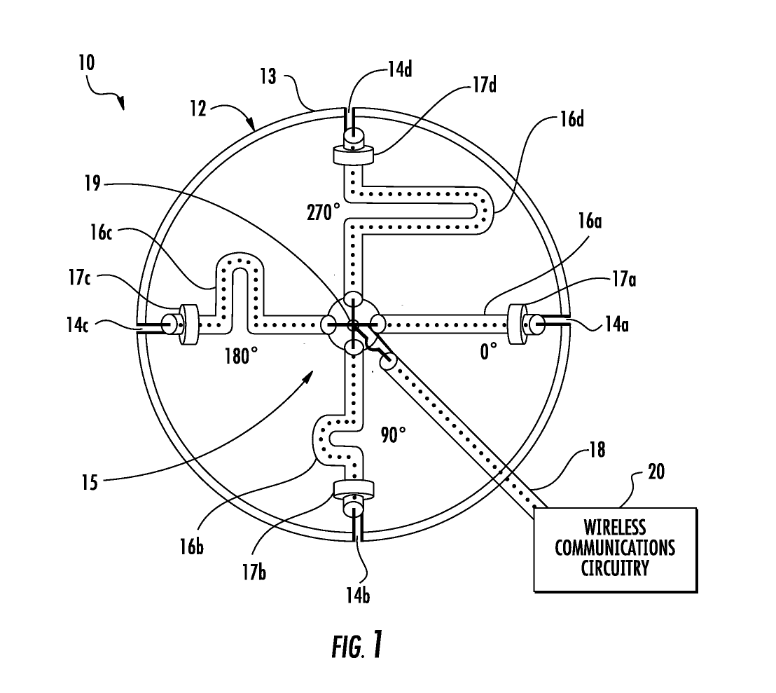

Referring initially to FIG. 1, a wireless communications device 10 includes wireless communications circuitry 20 and an antenna 12 coupled to the wireless communications circuitry 20. The wireless communications device 10 may be a satellite transceiver in some embodiments, and as such, the wireless communications circuitry 20 may include transmitter and/or receiver circuitry.

The antenna 12 comprises a loop electrical conductor 13, which is preferably circularly shaped. The loop electrical conductor 13 may be a metallic ring, circular wire, tubing hoop, a conductive trace, or may be a hole defined in a metallic surface, as will be appreciated by those of skill in the art. Approximations the circle shape may also be used, such as polygons. The loop electrical conductor 13 has four spaced apart gaps therein which define four respective spaced apart coupling points 14a, 14b, 14c, 14d. Each of the spaced apart gaps may create a pair of terminals on either side of the gap. The spaced apart coupling points 14a, 14b, 14c, 14d may comprise ports.

The spaced apart coupling points 14a, 14b, 14c, 14d are separated by one quarter of a length of the circumference of the loop electrical conductor 13, and the length of the loop electrical conductor itself corresponds to an operating wavelength of the antenna 12. In particular, good results may be obtained with the circumference of the loop electrical conductor 13 being equal to the operating wavelength of the antenna 12, although it should be noted that the loop electrical conductor 13 circumference may also be multiples and/or fractions of the operating wavelength.

The antenna 12 includes a feed assembly 15, to relay signals to and from the wireless communications circuitry 20, as well as to configure the antenna for different modes of operation, as will be explained in detail below. The feed assembly 15, in turn, includes an antenna feed 18 which is coupled to the wireless communications circuitry 20. The antenna feed 15 in turn is coupled to each of four signal feed lines 16a, 16b, 16c, 16d at a common node 19. The signal feed lines 16a, 16b, 16c, 16d are illustratively delay lines, but it should be understood that they need not be. Each delay line 16a, 16b, 16c, 16c is coupled to a respective one of the coupling points 14a, 14b, 14c, 14d. The feed assembly 15 divides radio frequency power four ways and delivers the divided power at different relative phases. Baluns 17a, 17b, 17c, 17d may be provided suppress common mode currents on feed assembly 15, such as ferrite beads. Baluns 15 may also be balun transformers to the match coupling point 14a, 14b, 14c, 14d impedances to the feed assembly 15, if desired.

As can be appreciated by those in the art, FIG. 1 depicts the delay lines 16a, 16b, 16c, 16c to be connected in parallel at the common node 19. This will provide equal power division into the four delay lines 16a, 16b, 16c, 16c when the impedance referred by the four delay lines 16a, 16b, 16c, 16d are equal. Of course other means of power division may also be used at the common node 19, such as series connections of the delay lines 16a, 16b, 16c, 16c, any combination of series and or parallel connections, a transformer with multiple windings, a branch line coupler, etc. as those in the art can appreciate.

Since the length of each delay line 16a, 16b, 16c, 16d is illustratively different, each delay line will refer a fraction of the transmit signal to the coupling points 14a, 14b, 14c, 14d at different relative phase, or in the receive case refer the fractions of the receive signal to antenna feed 18 in a reciprocal fashion to the transmit case. Here, the phases shifted versions of the transmit signal are referred to the coupling points 14a, 14b, 14c, 14c, or the phase shifted versions of the receive signal are referred to the antenna feed 18, at 0′, 90°, 180°, and 270° relative phase respectively. The feed assembly 15 may provide equal amplitude excitations in phase quadrature (0, 90, 180, 270 degrees) at the coupling points 14a, 14b, 14c, 14d. For example, if the wireless communications circuitry 20 provides 1 watt of RF power, then the feed assembly 15 provides ¼ watt of RF power to each of the coupling points 14a, 14b, 14c, 14d at relative phases of 0, 90, 180 and 270 degrees. This arrangement of phase differences results in a signal being transmitted with circular polarization, in particular right hand circular polarization is produced out of the page. This is because the equal amplitude quadrature phase excitations at the spaced apart coupling points 14a, 14b, 14c, 14d imparts a traveling wave current distribution on the loop electrical conductor 13.

The traveling wave current distribution will be further explained. A traveling wave current distribution means that the loop electrical conductor 13 has a sine wave current distribution which is moving around the circumference of the loop circumference at an angular velocity of ω=2πf. So to speak then, two “lumps of current” rotate around the loop electrical conductor 13 circumference. The two current maxima are opposite each other at all times. Since the flow of RF electric currents cause radio waves, and the RF currents are themselves rotating around the loop, then the transmitted wave must spin around its axis, which is circular polarization.

As background, prior art linearly polarized full wave loop antennas have an electrical current distributions on the loop conductor that does not spin around the loop circumference. Rather, the two current maxima stand still in space.

A theory of operation for a circular loop electrical conductor 13 will now be provided. The four equal amplitude quadrature phase excitations would if summed together in an ordinary fashion cancel and become zero, e.g. the vector sum of 1 [symbol] 0°+1 [symbol] 90°+1 [symbol] 180°+1 [symbol] 270°=0 The structure of the circular loop electrical conductor 13 however has dual properties of: 1) a radiating antenna and 2) a hybrid ring power combiner. So, the circular loop electrical conductor 13 can hybrid combine the RF powers at the coupling points 14a, 14b, 14c, 14d without cancellation, and this produces a traveling wave current distribution. The hybrid power combining properties of the circular loop electrical conductor 13 are as follows: port 14a is uncoupled from port 14b, port 14b is uncoupled from port 14c, port 14c is uncoupled from port 14d, and port 14d is uncoupled from port 14a, or stated as scattering parameters S_{14a14b}=0, S_{14b14c}=0, S_{14c14d}=0, S_{14d14a}=0. The quadrature excitation and hybrid combining in the loop electrical conductor 13 results in the superposition of sines and cosines in an extension of the Pythagorean Identity:

Iₗₒₒₚ=(sin θ)²+(cos θ)²+(−sin θ)²+(−cos θ)²

Where Iₗₒₒₚ is the current on the loop conductor 13. The sine term corresponds to the 0 degree excitation at coupling point 14a, the cosine to the 90 degree excitation at 14b, the −sine term to the 180 degree excitation at 14c, and the −cosine term to the 270 degree excitation at 14d. The traveling wave current distribution transduces a circularly polarized wave as it is moving in a circle.

If the delay lines 16a, 16b, 16c, 16c are sized such that the phase delay increases in the opposite sense as shown, the circular polarization will be left handed circular polarization produced into the page. So, increasing phase delay (such as more cable length) is introduced in a sense opposite that of the desired circular polarization sense. In addition, as will be appreciated by those of skill the art, the delay lines 16a, 16b, 16c, 16c need not cause the delay due to a mere function of their length, and need not have different lengths, but may include suitable phase shifting elements therein so as to produce the desired phase shift. Examples include coaxial cables having different permittivity dielectrics or ferrites, and ladder networks of inductors and capacitors.

Regarding the choice of circular polarization sense, right handed circular polarization may be preferential in the northern hemisphere, and left handed circular polarization may be preferable in the southern hemisphere, due to electron rotation (gyro resonance) in the ionosphere (see also “Ionospheric Radio Propagation”, K. Davies. National Bureau of Standards, Apr. 1, 1965).

The far field radiation pattern is the Fourier transform of the current distribution on the loop conductor 13, so the radiated field of the antenna 12 in the Z direction (normal to the loop plane) has a constant magnitude over time which is described by

E=(cos²ωt÷sin²ωt)^{1/2}=1

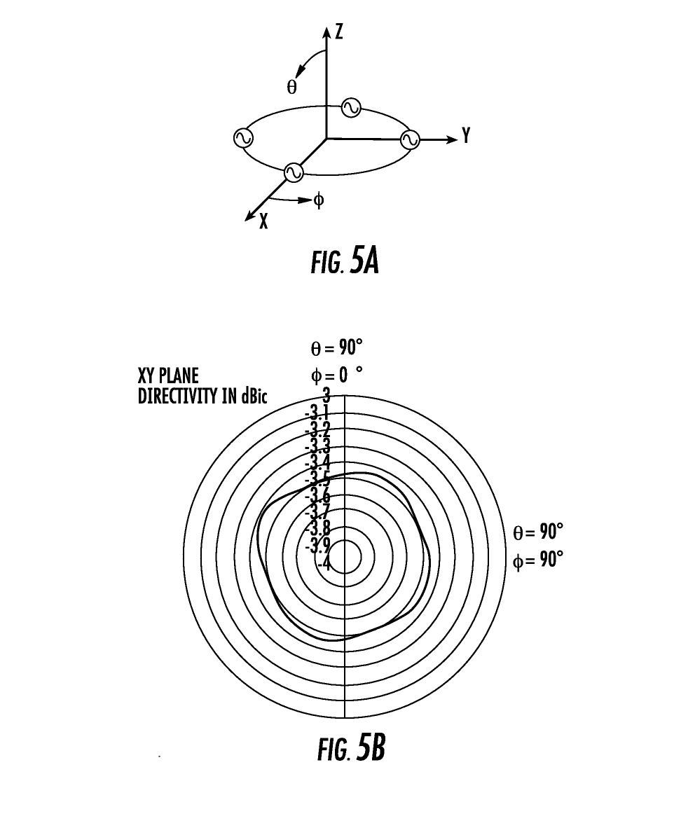

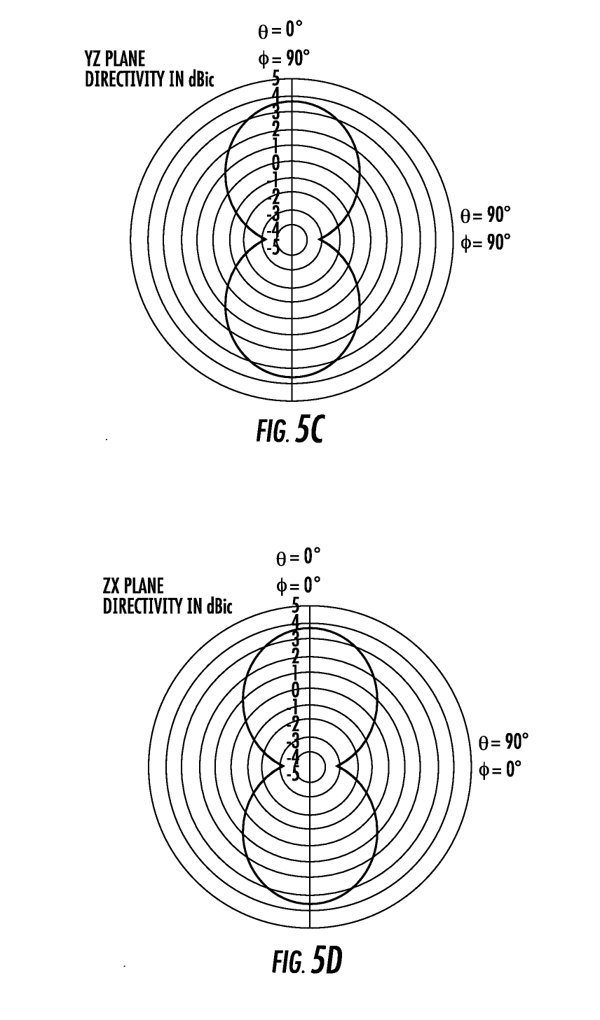

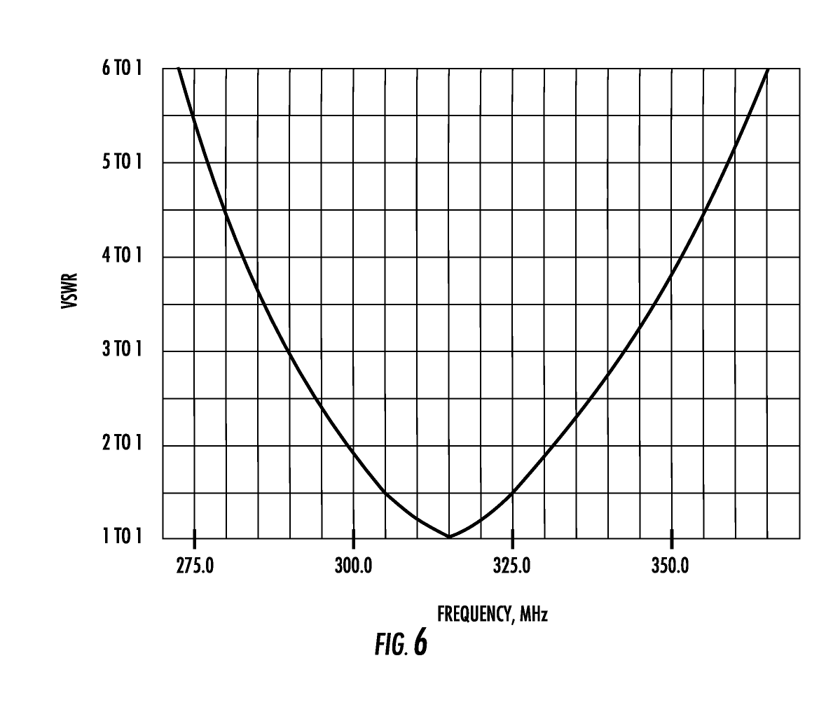

, which is the condition for circular polarization. ω is the orientation of the E field about the wave axis, e.g. the polarization angle, and t is time. FIG. 6 depicts the present invention in a standard radiation pattern coordinate system, and examples of the principal plane far field radiation pattern cuts (XY, YZ, ZX) for the present invention circularly polarized loop antenna are depicted in FIGS. 5B-5D. These patterns were obtained by moment method numerical electromagnetic modeling, and are for operation in free space. Total fields are plotted. The plotted quantity is directivity. The units are dBic, expressed in decibels relative to an isotropic radiator that is circularly polarized. If the antenna is efficiently matched and tuned the FIGS. 5B-5D also plot the realized gain in dBic, as can be appreciated by those in the art. The elevation cut patterns are a cosⁿ two petal rose and the two radiation pattern lobes are oriented broadside the loop plane. The half power beamwidth of those lobes is 98 degrees and the beams are symmetric in shape. The FIG. 5B azimuth cut in the loop plane is circular. So the antenna 12 has omnidirectional radiation about the horizon when the antenna plane is horizontal. The FIG. 5B plot uses a fine scale of 1/10 decibel per division to show that the azimuth plane pattern ripple is low, about +−0.25 decibel, and the highly circular azimuth pattern may for instance benefit radio location systems. The antenna 12 has no sidelobes. The gain at pattern peak is 3.6 dBic and this is 1.5 db more than a half wave dipole turnstile (U.S. Pat. No. 1,892,221, to Runge) provides. Polarization in the 5B-5D example was circular broadside to the loop plane and linear in the loop plane. When the loop electrical conductor 13 plane is horizontal the polarization there is horizontal. As background, polarization is the orientation of the E field vector of the far field radio wave.

If a large plane reflector (not shown) is spaced one quarter wavelength (λ/4) from the antenna 12 a single radiation pattern lobe is formed with 82 degrees beamwidth. When efficiently matched and tuned, the realized gain is 8.2 dBic. If a plane reflector is spaced relatively close to the antenna 12 a “patch antenna” may be formed.

The degree of polarization circularity produced by the FIG. 1 embodiment antenna 12 is extremely high and is nearly ideal. Axial ratios of 0.9999 and higher (perfect circular polarization axial ratio equals one) are achievable from the antenna 12 as the four coupling points 14a, 14b, 14c, 14d together enforce the loop current distribution. High axial ratio polarization circularity, from the present invention, may benefit say air traffic radar in looking through rain clutter as rain clutter reflections are known to return circular polarization in the opposite sense, and aircraft tend to be rather random scatterers of polarization.

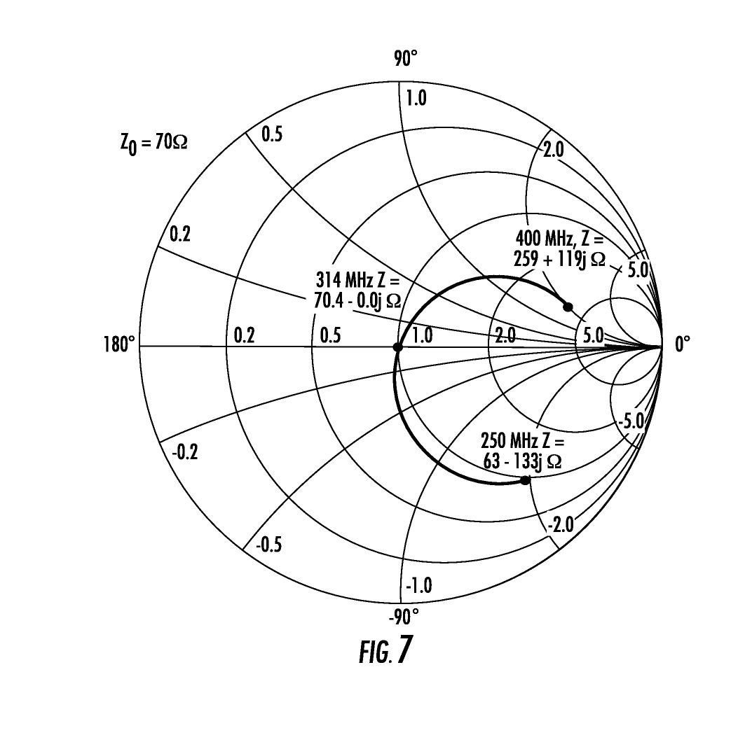

FIG. 6 depicts the voltage standing wave ratio (VSWR) response of a 1 meter circumference thin wire antenna 12 at each coupling point 14a, 14b, 14c, 14d. FIG. 6 is normalized to 70 ohms and as can be appreciated the VSWR is less than 1.1 to 1. So, the antenna 12 is advantageously suited for use with coaxial cables. The VSWR response is quadratic (single tuned), the 2 to 1 VSWR bandwidth at each coupling point 14a, 14b, 14c, 14d is 10.7 percent, and the 6 to 1 VSWR bandwidth is 30.1 percent. The 3 dB gain bandwidth of the antenna 12 may be also be 30.1 percent since a 6 to 1 VSWR may correspond to 3 dB mismatch loss. FIG. 7 plots the driving point impedance at each of the four coupling points 14a, 14b, 14c, 14d in Smith Chart format. For a thin wire loop electrical conductor 13 of wire diameter of λ/1000 the loop circumference is 1.05λ at resonance. The normalizing impedance in FIG. 7 was 70 ohms. As those in the art may appreciate the four delay lines 16a, 16b, 16c, 16d may preferentially have a characteristic impedance of 70 ohms in practice.

The FIG. 1 embodiment may of course provide elliptical polarization if unequal power divisions are provided at the coupling points 14a′, 14b′, 14c′, 14d′.

Fewer than four or more than four coupling points 14 may be used in antenna 12 but the combination of a loop electrical conductor 13 circumference near one wavelength with four equally spaced coupling points 14 is very effective.

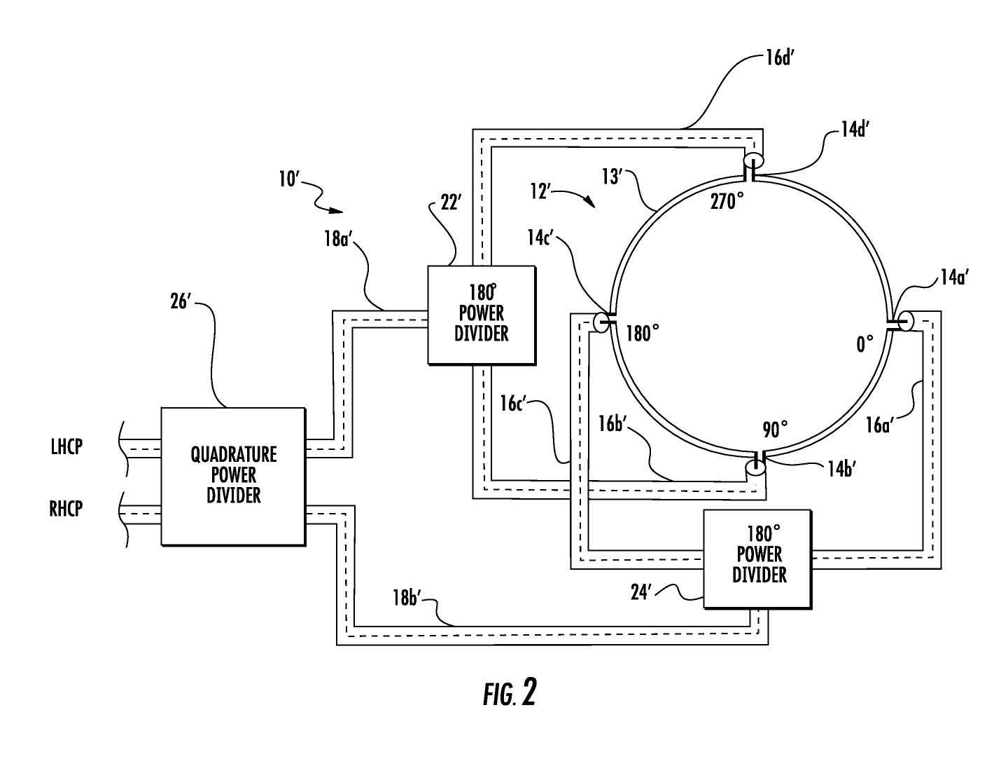

Now described with reference to FIG. 2 is an additional embodiment, wherein the antenna 12′ is configured for operation using simultaneous right hand and left hand circular polarization. The antenna 12 may provide polarization duplexing with high isolation between the opposite polarization senses.

Here, a quadrature hybrid unit 26′ drives the antenna 12′ at the coupling points 14a′, 14b′, 14c′, 14d′, providing 0 and 90 degree phasing at its outputs. In addition, here, there are two antenna feeds 18a′, 18b′, each of which feeds a power divider 22′, 24′, respectively. The power dividers are each coupled to two opposite coupling points (i.e. 14a′ and 14c′, and 14b′ and 14d′) by respective delay lines (i.e. 16a′ and 16c′, 16b′ and 16d′). Here, the delay lines 16a′, 16b′, 16c′, 16d′ are configured to provide phase delays of 0°, 90°, 180°, and 270°, respectively.

As explained, this design provides for transmission or reception of dual circularly polarized signals, allowing for simultaneous transmission of two separate signals. In addition, this design may be used for full duplex communications, where a transmitter may simultaneously be operated at coupling points 14a′ and 14c′, and a receiver at coupling points 14b′ and 14d′, without mutual interference.

This antenna 12′ provides a very high axial ratio which may approach 1.0. Such a high axial ratio means that there is little to no interference of the right hand circularly polarized signal caused by the left hand circularly polarized signal, or vice versa. This is highly desirable in satellite communications, for example for frequency reuse. In addition, this embodiment may be advantageous at high (HF) frequencies for NVIS (near vertical incidence skywave) communications.

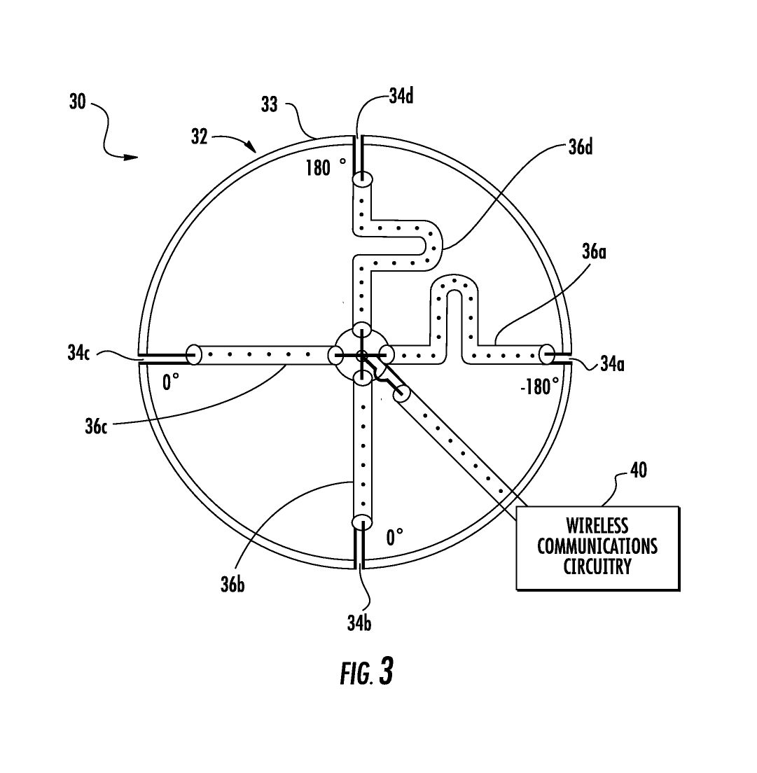

With reference to FIG. 3, a version of the antenna 32 that is configured for linear polarization operation rather than circular polarization is now described. This antenna 32 is similar to the antenna 12 described with reference to FIG. 1, but the delay lines 36a, 36b, 36c, 36d are sized differently. Here, the delay lines 36a, 36b, 36c, 36d are sized such that the phases at the coupling points 34a, 34b, 34c, 34d are −180°, 0°, 0°, and 180°, respectively.

This phase configuration results in linear polarization, rather than circular polarization. In particular, this antenna 32 produces horizontal linear polarization into and out of the page. If the phases at the coupling points were 34a, 34b, 34c, 34d reversed, the antenna 32 would produce vertical linear polarization into the page.

The radiation patterns for the FIG. 3 embodiment are similar to those of FIG. 5A-5C, except that that the loop plane null is deeper. Simulations have shown the gain there to be to −54 dBic and the null may be infinitely deep in theory. Reduced loop plane radiation may be advantageous to avoid interference to terrestrial communications when the antenna 32 is pointed overhead. The antenna 32 may have a standing wave current distribution.

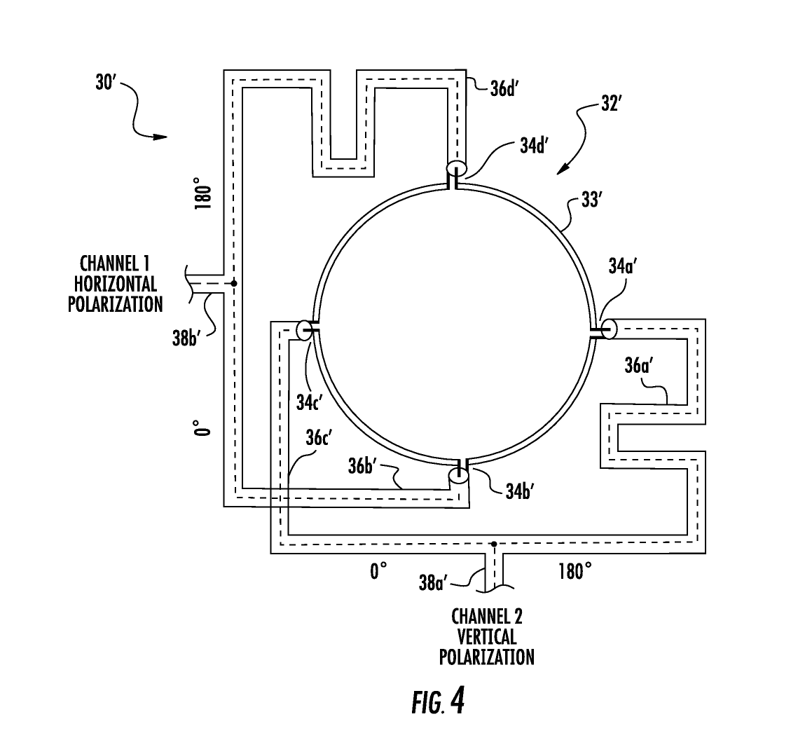

Now, an embodiment of the antenna 30′ that is configured for simultaneous operation using both horizontal and linear polarization, e.g. dual linear polarization or duplexed linear polarization is described with reference to FIG. 4. In this embodiment, there are two antenna feeds 38a′, 38b′ carrying a signal to be transmitted or received using vertical polarization, and a signal to be transmitted or received using horizontal polarization, respectively. The antenna feed 38a′ is coupled to two delay lines 36b′, 36d′, while the antenna feed 38b′ is coupled to the two delay lines 36a′, 3bc′. The delay lines are sized such that the phases at the coupling points 34a′, 34b′, 34c′, 34d′ are −180′, 0°, 0°, and 180°, respectively, thereby providing simultaneous horizontal and vertical polarization.

The ability to operate using both horizontal and vertical polarization simultaneously can provide polarization diversity, and may have the effect of producing greater penetration into buildings and difficult reception areas than a signal with just one plane of polarization. In the antenna 30′, the vertical polarized coupling points 34a′, 34c′ and horizontal polarized coupling points 34b′, 34d′ are isolated from one another, and may also be used as independent communication channels, or for duplex communications. For instance, a transmitter may be included at one of the signal feedpoints, and a receiver used at the other.

The embodiments of the present inventions are not so limited as to require gaps in the loop electrical conductor 13 to form the coupling points 14a, 14b, 14c, 14d. Other approaches may be utilized such as gamma matches, Y matches, or delta matches as are common for dipole and yagi-uda antenna driven elements. In this regard, the textbook “Antennas For All Applications”, John Kraus, Ronald J. Marhefka, 3^{rd} edition, Tata McGraw-Hill, 2002 is identified as a reference in its entirety and the FIG. 23-19 page 822 is referenced in specific.

Table 1 provides a comparison between the antenna 12 and the circularly polarized half wave dipole turnstile antenna:

TABLE 1
Comparison Of The Antenna 12 With The Dipole Turnstile

| | Antenna 12, | |
|---|---|---|
| | Circularly | ½ Wave Dipole |
| Parameter | Polarized Loop | Turnstile |
| Physical | 0.33λ circle | 0.34λ by 0.34λ |
| dimensions | | square (dipoles run |
| | | from corner to |
| | | corner) |
| Subtended | 0.08λ² | 0.12λ² |
| area | | |
| Wire | λ/1000 | λ/1000 |
| diameter | | |
| Realized | 3.6 dBic | 2.1 dBic |
| gain | | |
| Half power | 98 degrees | 126 by 172 degrees |
| beamwidth | | |
| Port | 70 + j0 | 72 + j0 |
| impedances | | |
| 2 to 1 VSWR | 10.7 percent | 11.2 percent |
| bandwidth, | | |
| each port | | |
| 3 dB gain | 30.1 percent | 33.7 percent |
| bandwidth | | |
| Polarization | Circular | Circular |

A full wave circularly polarized loop antenna 12 therefore provides many advantages over the prior art half wave dipole turnstile: more gain, a symmetric beam, reduced size. The bandwidth for size is greater with the loop 12. The antenna 12 provides circular polarization of exceptional circularity: unlike the turnstile it is not easily upset by tolerances. So, the antenna 12 may replace the turnstile in many applications such as satellite communications and ionospheric communications.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A wireless communications device comprising:
wireless communications circuitry; and
an antenna coupled to said wireless communications circuitry and comprising
a loop electrical conductor having four spaced apart gaps therein defining four respective spaced apart coupling points, and
a feed assembly comprising
at least one antenna feed, and
four signal feed lines,
each signal feed line coupled between said at least one antenna feed and a respective one of said four coupling points.

2. The wireless communications device of claim 1, wherein the spaced apart coupling points are separated by one quarter of a length of the loop electrical conductor; and wherein the length of said loop electrical conductor corresponds to an operating wavelength of said antenna.

3. The wireless communications device of claim 1, wherein said four signal feed lines provide phase delays of 0°, 90°, 180°, and 270°, respectively.

4. The wireless communications device of claim 1, wherein said four signal feed lines provide phase delays of −180°, 0°, 0°, and 180°, respectively.

5. The wireless communications device of claim 1, wherein said at least one antenna feed comprises a pair of antenna feeds; wherein said feed assembly further comprises a respective power divider coupled to each antenna feed; wherein signal feed lines for opposite coupling points are coupled to a same power divider; and wherein said four signal feed lines provide phase delays of 0°, 90°, 180°, and 270°, respectively.

6. The wireless communications device of claim 1, wherein said at least one antenna feed comprises a pair of antenna feeds; wherein said feed assembly comprises a respective power divider coupled to each antenna feed; wherein signal feed lines for opposite coupling points are coupled to a same power divider; and wherein said four signal feed lines provide phase delays of −180°, 0°, 0°, and 180°, respectively.

7. The antenna of claim 1, wherein said loop electrical conductor comprises a circular electrical conductor.

8. An antenna for use in a wireless communications device comprising:
a loop electrical conductor having four spaced apart gaps therein defining four respective spaced apart coupling points; and
a feed assembly comprising
at least one antenna feed, and
four signal feed lines, each signal feed line coupled between said at least one antenna feed and a respective one of said four coupling points.

9. The antenna of claim 8, wherein the spaced apart coupling points are separated by one quarter of a length of the loop electrical conductor; and wherein the length of said loop electrical conductor corresponds to an operating wavelength of said antenna.

10. The antenna of claim 8, wherein said four signal feed lines provide phase delays of 0°, 90°, 180°, and 270°, respectively.

11. The antenna of claim 8, wherein said four signal feed lines provide phase delays of −180°, 0°, 0° and 180°, respectively.

12. The antenna of claim 8, wherein said at least one antenna feed comprises a pair of antenna feeds; wherein said feed assembly further comprises a respective power divider coupled to each antenna feed; wherein signal feed lines for opposite coupling points are coupled to a same power divider; and wherein said four signal feed lines provide phase delays of 0°, 90°, 180°, and 270°, respectively.

13. The antenna of claim 8, wherein said at least one antenna feed comprises a pair of antenna feeds; wherein said feed assembly comprises a respective power divider coupled to each antenna feed; wherein signal feed lines for opposite coupling points are coupled to a same power divider; and wherein said four signal feed lines provide phase delays of −180°, 0°, 0°, and 180°, respectively.

14. The antenna of claim 8, wherein said loop electrical conductor comprises a circular electrical conductor.

15. A method of making an antenna to be used in a wireless communications device comprising:
forming a loop electrical conductor having four spaced apart gaps therein defining four respective spaced apart coupling point; and
forming a feed assembly by forming four signal feed lines and coupling each of the four signal feed lines between at least one antenna feed and a respective one of the four coupling points.

16. The method of claim 15, wherein the loop electrical conductor is formed such that the spaced apart coupling points are separated by one quarter of a length of the loop electrical conductor, and that the length of the loop electrical conductor corresponds to an operating wavelength of the antenna.

17. The method of claim 15, wherein the four signal feed lines are formed to provide phase delays of 0°, 90°, 180°, and 270°, respectively.

18. The method of claim 15, wherein the four signal feed lines are formed to provide phase delays of −180°, 0°, 0°, and 180°, respectively.

19. The method of claim 15, wherein the loop electrical conductor is formed to have a circular shape.
